(19) United States
(12) Patent Application Publication
(10) Pub. No.: US 2026/0295882 A1
(43) Pub. Date: Oct. 1, 2026

(54) MINERAL WOOL FACING TOOL

(71) Applicant: Ames Tools Corporation, Suwanee, GA (US)

(72) Inventors: Michael T. Ventura, Palm Beach Gardens, FL (US); Lang Cheng, Chang Zhou (CN)

(21) Appl. No.: 19/178,470

(22) Filed: Apr. 14, 2025

(30) Foreign Application Priority Data
Mar. 28, 2025 (CN) 202510388597.X

(51) Int. Cl. B26D 3/08

(52) U.S. Cl. CPC B26D 3/085

(57) ABSTRACT

A mineral wool facing tool includes a base defining a first substantially planar surface configured to move along the rough face of the sheet of mineral wool and a second surface opposite the first substantially planar surface and separated from the first substantially planar surface by a thickness of the base. The mineral wool facing tool includes a first handle coupled to the second surface and a second handle spaced apart from the first handle and coupled to the second surface. A blade has a cutting edge that extends from and along the length of the elongated edge of the base. In response to sliding movement of the first substantially planar surface of the base along the rough face of the mineral wool sheet, the cutting edge is configured to remove material from the rough face to yield a substantially planar face on the mineral wool sheet.

### CROSS-REFERENCE TO RELATED APPLICATIONS

This application claims priority to Chinese Application No. 202510388597.X, filed Mar. 28, 2025, the entire contents of which are incorporated herein.

### FIELD OF THE INVENTION

The present invention relates to mineral wool cutting tools and, more particularly, to such tools for shaving or planing a face of a mineral wool material.

### BACKGROUND OF THE INVENTION

Mineral wool, also known as stone wool, is used in a wide range of applications based on thermal, acoustic, and fire-resistant properties. Mineral wool is used as insulation within walls of a building to assist in maintaining an internal temperature of the rooms within the building and to further provide soundproofing and fire resistance. Some mineral wool materials are usable as an external material (i.e., not within a wall) where the mineral wool is visible or otherwise the backing substrate for a visible finish, such as a stucco, synthetic stucco, or other suitable exterior coating. Mineral wool materials are limited in their use as external design materials based at least partially on the difficulty of shaping and shaving the material on-site. The techniques described herein cure this deficiency of the prior art.

Scalloped knives are typically used to cut mineral wool sheets 500 to length (i.e., cutting fully through the sheet); however, the scalloped knives available within the prior art are not useful in planing or facing the mineral wool material. In a related field, hot foam cutters use a heated wire or blade (e.g., nickel chromium) to cut through foam materials, though these do not work to cut through mineral wool, which is significantly denser than most foam materials, includes many individual fibers that need to be severed, and is significantly more heat resistant.

### SUMMARY OF THE INVENTION

In some aspects, the techniques described herein relate to a mineral wool facing tool configured to remove material from a rough face of a mineral wool sheet, the mineral wool facing tool including: a base defining: a first substantially planar surface configured to move along the rough face of the sheet of mineral wool, the substantially planar surface having a height and a length, the length being at least three times greater than the height such that an elongated edge is defined by the first substantially planar surface; and a second surface opposite the first substantially planar surface and separated from the first substantially planar surface by a thickness of the base, the height and the length of the first substantially planar surface being greater than the thickness; a first handle coupled to the second surface; a second handle spaced apart from the first handle and coupled to the second surface; and a blade having a cutting edge that extends from and along the length of the elongated edge of the base, wherein in response to sliding movement of the first substantially planar surface of the base along the rough face of the mineral wool sheet, the cutting edge is configured to remove material from the rough face to yield a substantially planar face on the mineral wool sheet.

In some aspects, the techniques described herein relate to a mineral wool facing tool, wherein the blade includes a toothed edge or a scalloped edge.

In some aspects, the techniques described herein relate to a mineral wool facing tool, wherein each of the first handle and the second handle is D-shaped.

In some aspects, the techniques described herein relate to a mineral wool facing tool, wherein the first handle is configured as a knob that is rotatable relative to the base.

In some aspects, the techniques described herein relate to a mineral wool facing tool, wherein the blade extends in a plane, wherein the blade is coplanar with the first substantially planar surface, and wherein the cutting edge is configured to face the rough face within the plane.

In some aspects, the techniques described herein relate to a mineral wool facing tool, wherein the blade is removable from the base and is coupled to the base via a plurality of fasteners.

In some aspects, the techniques described herein relate to a mineral wool facing tool, wherein the base overlaps a portion of the blade along a full length of the blade.

In some aspects, the techniques described herein relate to a mineral wool facing tool, wherein the blade includes a first blade positioned end-to-end adjacent to a second blade.

In some aspects, the techniques described herein relate to a mineral wool facing tool, further including a tool holder coupled to the first substantially planar surface and a tool configured to remove the blade from the base coupled to the tool holder.

In some aspects, the techniques described herein relate to a mineral wool facing tool, further including a blade guard configured to cover a cutting edge of the blade in a use position and magnetically couple to the base in a stowed position.

In some aspects, the techniques described herein relate to a method of operating a mineral wool facing tool, the mineral wool facing tool including a base defining a first substantially planar surface configured to move along a rough face of a sheet of mineral wool and a second surface opposite the first substantially planar surface and separated from the first substantially planar surface by a thickness of the base, a first handle coupled to the second surface, a second handle spaced apart from the first handle and coupled to the second surface, and a blade having a cutting edge that extends from and along a length of an elongated edge of the base, the method including: pressing the first substantially planar surface against the rough face of the mineral wool sheet; and moving the mineral wool facing tool back and forth along a longitudinal direction of the mineral wool facing tool along the rough face while simultaneously moving the mineral wool facing tool downward along the rough face, causing the blade to remove material from the rough face to yield a substantially planar face on the mineral wool sheet.

In some aspects, the techniques described herein relate to a method, wherein moving the mineral wool facing tool back and forth along the longitudinal direction and along the rough face includes moving the mineral wool facing tool over a seam between the mineral wool sheet and an adjacent mineral wool sheet to make the faces of the two adjacent mineral wool sheets coplanar.

In some aspects, the techniques described herein relate to a mineral wool facing tool configured to remove material from a rough face of a mineral wool sheet, the mineral wool facing tool including: a base defining: a first substantially planar surface configured to move along the rough face of the sheet of mineral wool, the first substantially planar surface having a height and a length such that an elongated edge is defined by the first substantially planar surface; and a second surface opposite the first substantially planar surface and separated from the first substantially planar surface by a thickness of the base, the height and the length of the first substantially planar surface being greater than the thickness; a first handle extending from the second surface; a second handle spaced apart from the first handle; and a blade having a cutting edge that extends from and along the length of the elongated edge of the base, wherein the blade extends in a plane, wherein the blade is coplanar with the first substantially planar surface, and wherein the cutting edge is configured to face the rough face within the plane.

In some aspects, the techniques described herein relate to a mineral wool facing tool, wherein the blade includes a toothed edge or a scalloped edge.

In some aspects, the techniques described herein relate to a mineral wool facing tool, wherein each of the first handle and the second handle is D-shaped.

In some aspects, the techniques described herein relate to a mineral wool facing tool, wherein the first handle is configured as a knob that is rotatable relative to the base.

In some aspects, the techniques described herein relate to a mineral wool facing tool, wherein the blade is removable from the base and is coupled to the base via a plurality of fasteners.

In some aspects, the techniques described herein relate to a mineral wool facing tool, wherein the base overlaps a portion of the blade along a full length of the blade.

In some aspects, the techniques described herein relate to a mineral wool facing tool, wherein the blade includes a first blade positioned end-to-end adjacent to a second blade.

In some aspects, the techniques described herein relate to a mineral wool facing tool, further including a tool holder coupled to the first substantially planar surface and a tool configured to remove the blade from the base coupled to the tool holder.

### BRIEF DESCRIPTION OF THE DRAWINGS

FIG. 1A is a perspective view of a mineral wool facing tool having a toothed blade.

FIG. 1B is a perspective view of a mineral wool facing tool having a scalloped blade.

FIG. 2 is a front view of the mineral wool facing tool of FIG. 1A.

FIG. 3 is a top view of the mineral wool facing tool of FIG. 1A.

FIG. 4 is a is a rear view of the mineral wool facing tool of FIG. 1A.

FIG. 5 is a side view of the mineral wool facing tool of FIG. 1A.

FIG. 6A is a perspective view of a mineral wool facing tool according to another embodiment.

FIG. 6B is a perspective view of a mineral wool facing tool according to yet another embodiment.

FIG. 7 is a side view of the mineral wool facing tool of FIG. 6B.

FIG. 8 is an enlarged perspective view of the scalloped blade of the mineral wool facing tool of FIG. 6B.

FIG. 9 is a perspective view of a mineral wool facing tool in use.

FIG. 10A is a front view of the toothed blade of FIG. 1A.

FIG. 10B is a side view of the toothed blade of FIG. 1A.

FIG. 10C is an enlarged side view of the teeth of the toothed blade of FIG. 1A.

FIG. 10D is an enlarged front view of the teeth of the toothed blade of FIG. 1A.

FIG. 10E is a perspective view of the toothed blade of FIG. 1A.

FIG. 11A is a front view of the scalloped blade of FIG. 1B.

FIG. 11B is an enlarged front view of the edge of the scalloped blade of FIG. 1B.

FIG. 11C is an enlarged side view of the edge of the scalloped blade of FIG. 1B.

FIG. 11D is a perspective view of the scalloped blade of FIG. 1B.

FIG. 12 is a perspective view of seams between multiple mineral wool sheets.

FIG. 13 is a perspective view of the mineral wool facing tool of FIG. 6B being used to face the mineral wool sheets of FIG. 12.

FIG. 14 is a perspective view of a portion of the mineral wool facing tool of FIG. 1A.

FIG. 15 is a perspective view of the portion of the mineral wool facing tool of FIG. 14 with a blade guard shown in a stowed position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

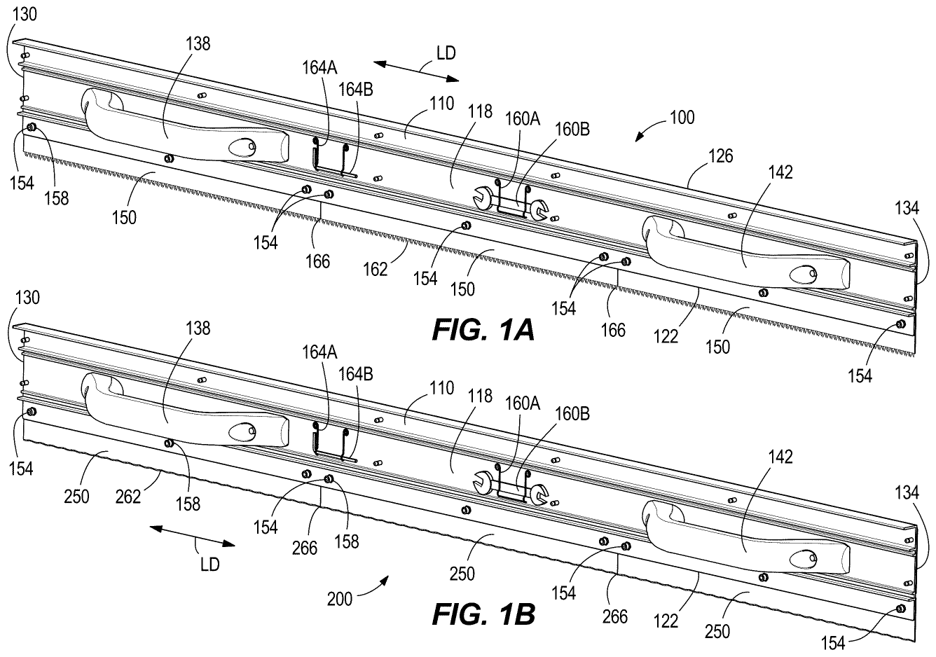

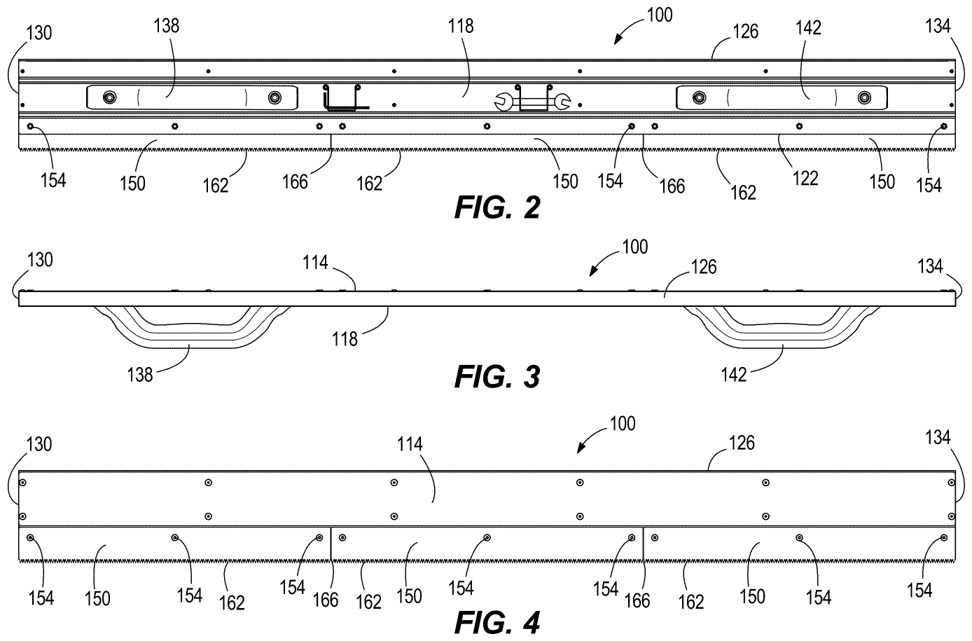

FIG. 1A illustrates a mineral wool facing tool 100 for facing (i.e., shaving, planing) an rough (e.g., uneven) surface 510 of a batt or sheet of mineral wool 500 (FIG. 9). The mineral wool facing tool 100 includes a base 110 for sliding along the mineral wool 500, a blade 150 for facing the sheet of mineral wool 500, and a pair of handles 138, 142 for a user to grasp when moving the base 110 and blade 150 across the face of the mineral wool sheet 500. The mineral wool facing tool 100 faces the sheet 500. Within the context of this application, facing refers to the removal of material 520 (FIG. 9) from a large planar face 510 of the sheet 500. Facing is a cut that is substantially parallel to the face being faced, similar to a planing or shaving operation. Facing of the sheet 500 may be useful in situations in which the sheet 500 is placed on a non-planar surface, creating a ripple or other protrusion on the outside, visible face of the sheet 500. In other situations, two sheets 500 may be placed adjacent to one another with the seam between the two sheets 500 being non-planar, in which the mineral wool facing tool 100 is configured to clean the seam by facing one or both of the two sheets 500 500 until the incongruity within the seam is eliminated.

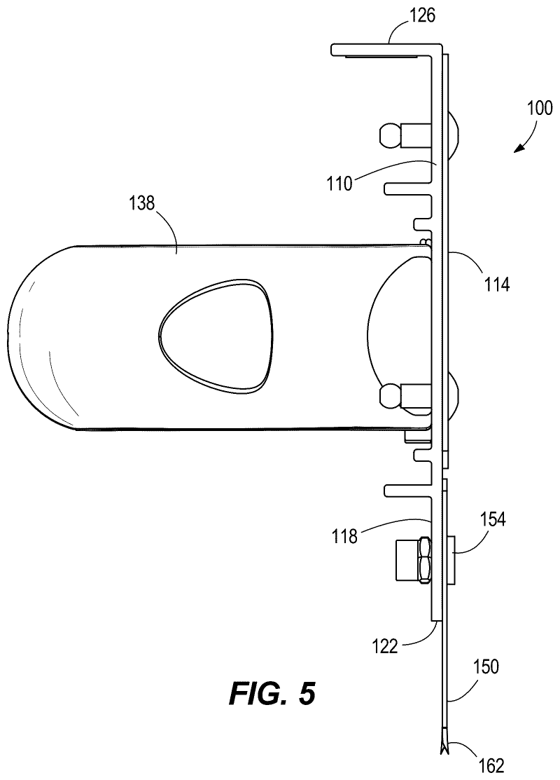

The base 110 is generally planar and includes a first surface 114 (FIG. 4) configured to ride along the face of the sheet 500 to be faced. In some embodiments, the first surface 114 is formed separately from and attached to the remainder of the base 110 such that the first surface 114 is formed of a material having properties to assist in smooth movement along the surface of the sheet 500. In other embodiments, the first surface 114 is formed integrally with the remainder of the base 110. A second surface 118 is opposite the first surface 114, with a thickness of the base 110 defined between the first and second surfaces 114, 118. Each of the first and second surfaces 114, 118 are generally rectangular and generally planar, though, as shown in FIG. 5, the second surface 118 includes a plurality of longitudinal protrusions that assist in providing rigidity to the base 110. The base 110 extends in and is elongated in a longitudinal direction LD between first and second lengthwise ends 130, 134. The base 110 has a height defined between opposing lower and upper edges 122, 126 that run the length of the base 110 between the first and second ends 130, 134. The base 110 is substantially rectangular, having a length (in the longitudinal direction LD) that is substantially greater than its height (with each of the length and height significantly greater than the thickness). In some embodiments, the length of the base 110 is at least three times greater than the height. In further embodiments, the length of the base 110 is at least five times greater than the height. In still further embodiments, the length of the base 110 is at least ten times (e.g., 10-15 times, 10-20 times) greater than the height. In the embodiment shown in FIG. 9, the length of the base 110 is greater than the width of the sheet 500 (e.g., at least 36 inches, at least 48 inches) such that the entire width of the sheet 500 can be faced in a single pass.

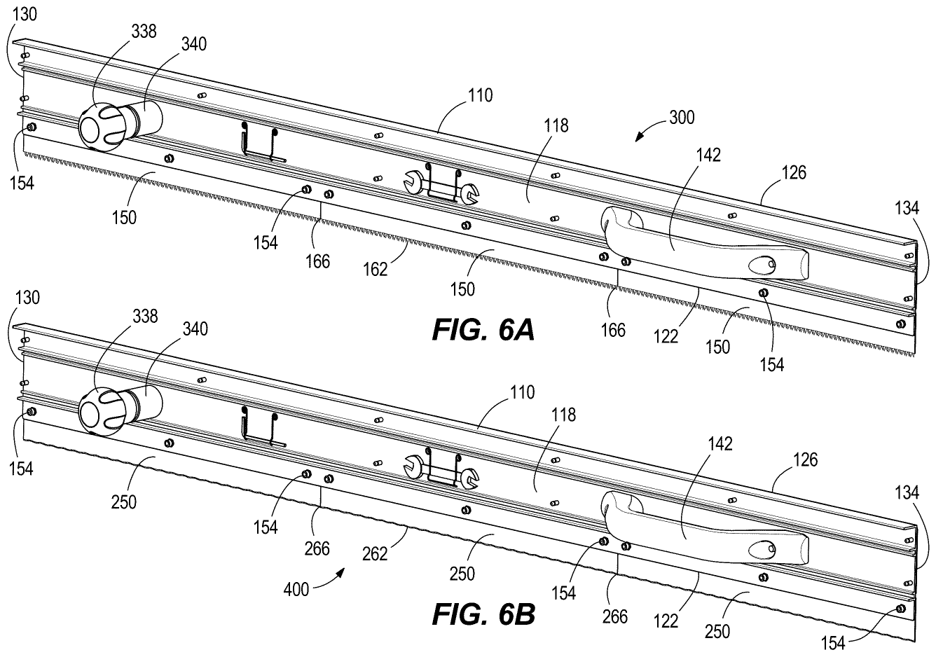

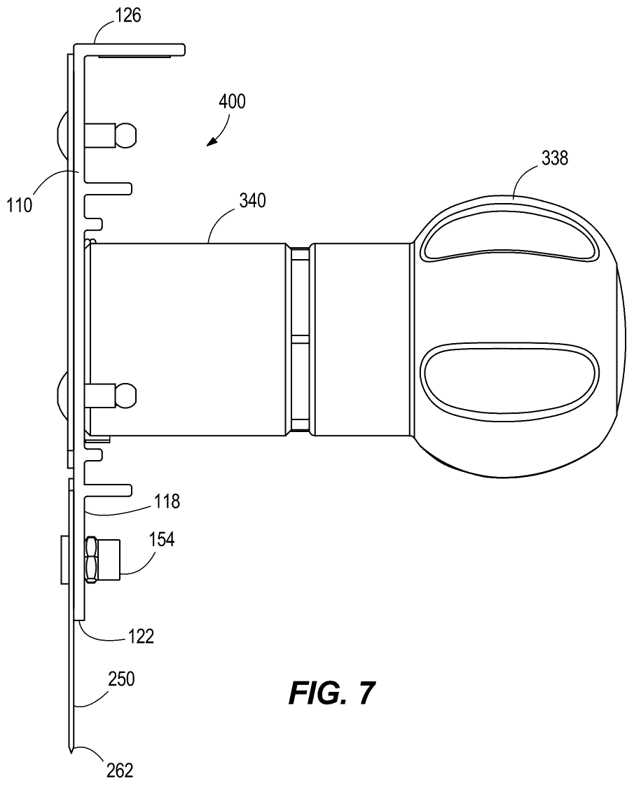

The second surface 118 supports first and second handles 138, 142 for a first hand and a second hand of a user, respectively. As shown, the first handle 138 is located nearer to the first longitudinal end 130 of the base 110 and the second handle 142 is located nearer to the second longitudinal end 134. As such, a user has control over the full length of the mineral wool facing tool 100 with a hand grasping each of the handles 138, 142. Each of the handles 138, 142 is coupled to the base 110 via one or more (e.g., two) fasteners, such as threaded fasteners, passing through openings in the base 110 and the respective handle 138, 142. In the embodiments shown in FIGS. 1A and 1B, each of the handles 138, 142 is identical, with each handle 138, 142 formed as a D-shaped handle (the handle itself forming the curved portion of the D-shape and the second surface 118 of the base 110 forming the straight portion of the D-shape) having a gripping surface about which a user can wrap their fingers to grasp the handle 138, 142. With reference to the embodiments shown in FIGS. 6A-6B and 7, the first handle 138 is replaced by a knob 338 coupled to a cylindrical base 340. As shown, the cylindrical base 340 is coupled to the base 110 and the knob 338 is coupled to the cylindrical base 340. In some embodiments, the knob 338 is rotatable relative to the cylindrical base 340. The rotatable knob 338 allows a user to pivot the mineral wool facing tool 300, 400 about a rotational axis of the handle 338, which may be useful in various cutting operations.

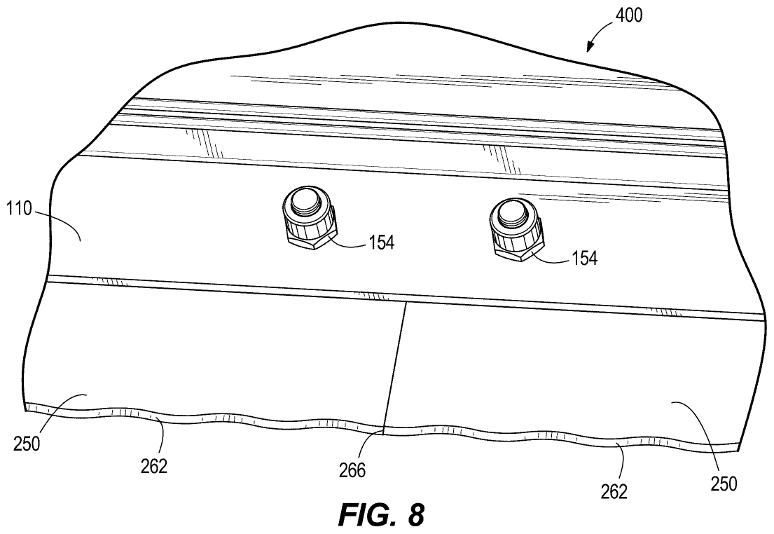

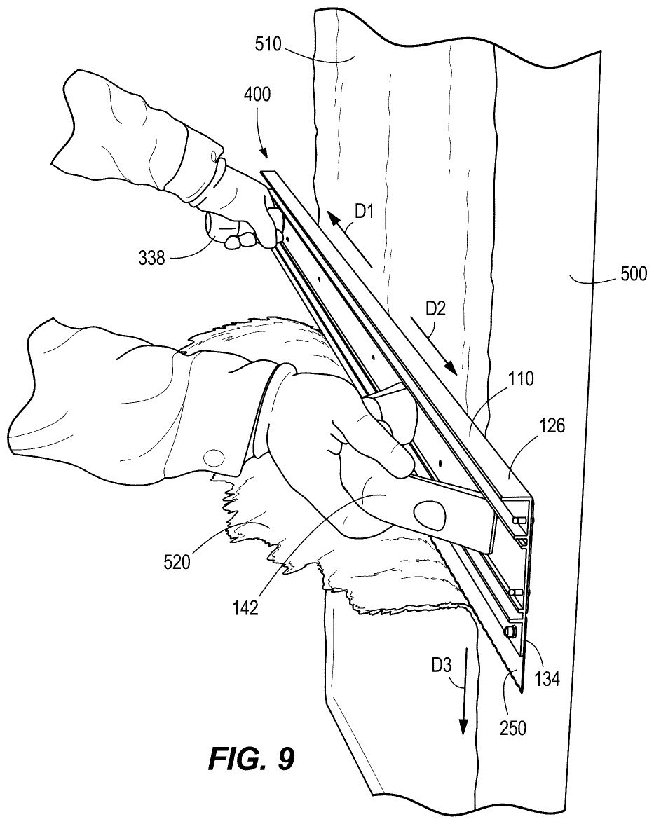

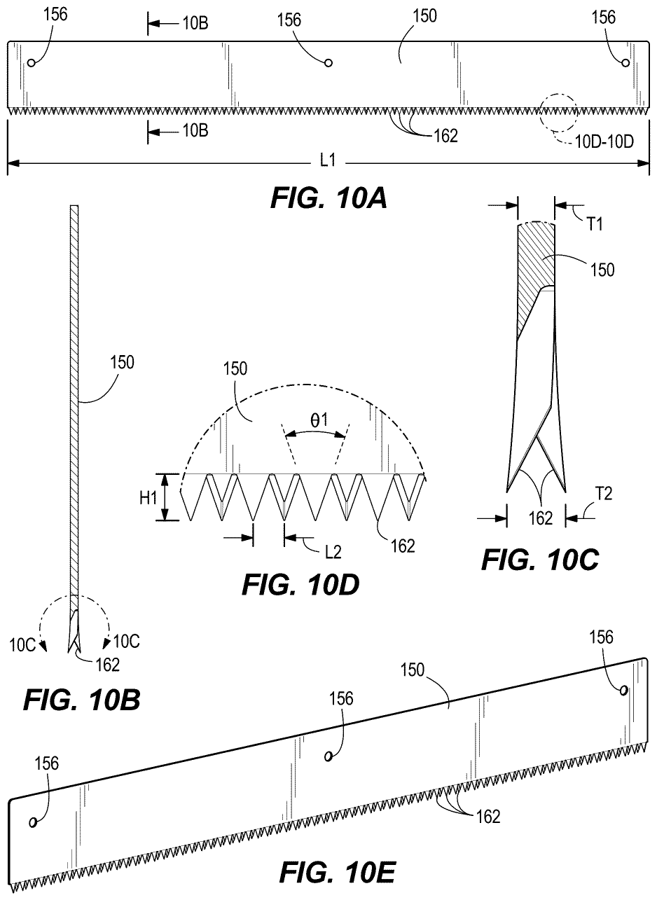

With continued reference to FIG. 1A, a blade 150 is affixed to the base 110 to facilitate facing of the sheet 500. As shown, the blade 150 is affixed at the lower edge 122 of the base 110 via a plurality of fasteners 154 (e.g., threaded fasteners such as through bolts) extending through openings 158 formed in the base 110 (adjacent lower edge 122) and similar openings 156 (FIGS. 10A, 10E) formed within the blade 150 itself. The openings 156, 158 overlap one another such that when the blade 150 is attached to the base 110, the base 110 overlaps at least a portion of the blade 150, as shown in greater detail in FIG. 5. A cutting edge 162 of the blade 150 is formed on a lower edge of the blade 150. As shown, the blade 150 extends the full length of the base 110 between the two longitudinal ends 130, 134. In the illustrated embodiment, the blade 150 is coplanar with the first surface 114, which rides along the face of the sheet 500 to be faced. In some embodiments, such as shown in FIG. 4, the blade 150 includes multiple (e.g., three) blades 150 placed end-to-end next to one another, forming a seam 166 between the adjacent blades 150. As shown in greater detail in FIG. 8, a first end of each blade edge 152, 262 corresponds to the opposite second end such that a continuous blade edge is maintained across the multiple blades 150, 250. By utilizing multiple shorter blades 150 to cover the full length of the base 110, manufacturability is simplified, and transportation and storage of replacement blades is made more manageable.

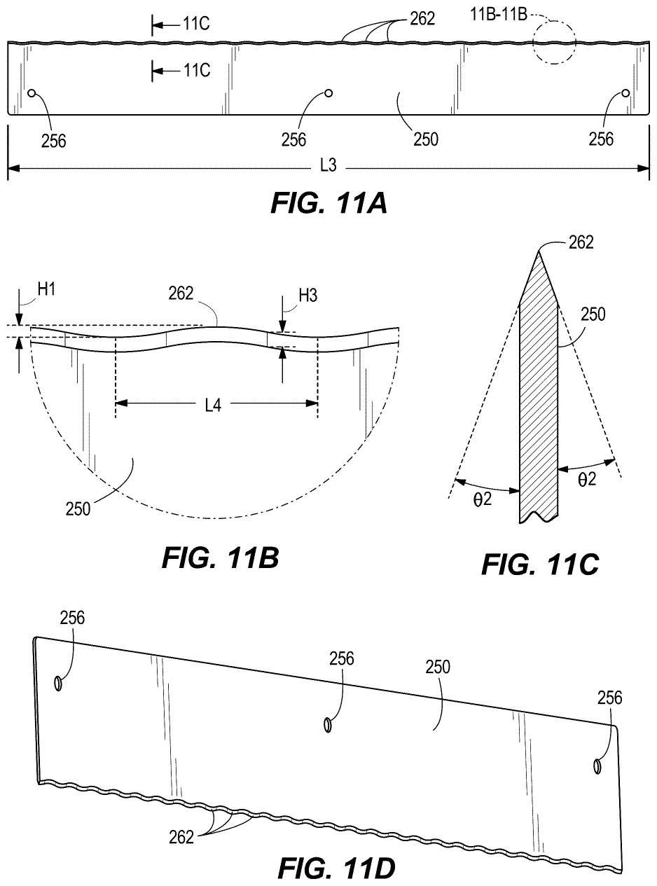

The cutting edge 162 shown in FIG. 1A is a toothed cutting edge having a plurality of individual teeth configured to cut through the mineral wool material. FIG. 1B illustrates a mineral wool facing tool 200 similar to the mineral wool facing tool 100 of FIG. 1A, with the blade 150 replaced by a scalloped blade 250 having a scalloped blade edge 262 as described and shown in greater detail with respect to FIGS. 11A-11D. In some instances, a scalloped blade edge may provide additional functionality, such as allowing for cutting in both directions (D1, D2; FIG. 9), and avoids pulling the fibers of the mineral wool material. In some embodiments, the scallop is on one side of the blade 250, such that the other side is smooth, essentially smoothing the cut as the blade 250 moves (i.e., within the motions of D1, D2, and D3, as shown in FIG. 9) through the material 500.

FIG. 1A illustrates first and second tool holders 160A, 164A coupled to the second surface 118 of the base 110, spaced apart from one another between the two handles 138, 142. The tool holders 160A, 164A are each configured to hold a tool 160B, 164B utilized for disassembling and reassembling the blade 150 to the base 110 (e.g., for replacement of the blade 150). In some embodiments, the tool holders 160A, 164A flex relative to the base 110 to selectively grab and release the respective tool 160B, 164B. In the embodiment shown, the first tool holder 160A supports a wrench 160B and the second tool holder 164A supports a hex key 164B. In the embodiment shown, the wrench 160B and the hex key 164B are usable together to remove and reassemble the fasteners 154 from the base 110 and the blade 150 to facilitate replacement of the blade 150. In other embodiments having other fasteners, different tools (e.g., screwdriver, a second wrench, etc.) may be coupled to the two tool holders 160A, 164A.

FIGS. 10A-10E illustrate the toothed blade 150 in greater detail. FIG. 10A illustrates the length L1 of the blade 150. The length L1 is, in some embodiments, the same as the length of the base 110. In other embodiments, the length L1 is an even fraction (e.g., ½, ⅓, ¼) of the length of the base 110 such that a plurality of blades 150 (e.g., two, three, or four blades) span the full length of the base 110. In some embodiments, the length L1 is approximately 16 inches. FIGS. 10B-10C illustrate that the teeth of the toothed edge 162 of the blade 150 alternate sides with every tooth. As shown, the outward trajectory of the teeth result in an overall width T2 (e.g., approximately 0.040 inches-0.060 inches) of the teeth that is greater than a width T1 (e.g., approximately 0.030 inches) of the remainder of the blade. FIG. 10D illustrates individual teeth of the toothed cutting edge 162. In some embodiments, a distance L2 between adjacent teeth may be, for example, 0.100-0.150 inches, or approximately ⅛ of an inch. In some embodiments, the height H1 of the teeth is 0.150-0.200 inches or approximately 3/16 of an inch. In some embodiments, the angle θ₁ of the tooth is approximately 35-40 degrees.

FIGS. 11A-11D illustrate the scalloped blade 250 in greater detail. FIG. 11A illustrates the length L3 of the blade 250, which is similar to the length L1 of the blade 150. FIG. 11C illustrates that the scalloped edge 262 of the blade 250 is tapered to a point or tip, with each side of the blade 250 extending towards the tip at an angle θ₂ of, for example, 20 degrees. With reference to FIG. 11B, in some embodiments, the sinusoidal deviation H2 of the cutting edge 262 is approximately 0.030 inches. In some embodiments, the height H3 of the cutting edge 262 is approximately 0.040-0.050 inches.

In use, the mineral wool shaving tool 400 (shown in FIG. 9, though could otherwise be the tool 100, 200, or 300) may be utilized to correct a mineral wool sheet 500 that is adhered or otherwise fastened over a wall or other surface that is not planar. The surface may be non-planar due to, for example, excess material (such as gravel/concrete from a concrete or masonry process) on the surface that creates a lump or high spot in the wool. In other instances, the surface backing the sheet 500 may be non-planar due to a deformity in the surface (such as a bowed wall or plywood). As shown in FIG. 9, the user places a hand on each of the two handles 136, 142 (or alternatively the knob 338 and handle 142, if using the tool 400 as shown in FIG. 9) and places the first surface 114 of the base 110 against the face 510 of the sheet 500 to be faced. The blade 250 is likewise placed against the face 510 when the first surface 114 is placed against the face 510, though the cutting edge 262 extends substantially parallel with the face 510 such that the blade 250 is not cutting transverse to the desired plane of the face 510. With the tool 100 pressed against the surface 510 of the sheet 500, the user translates the tool 400 back and forth along the directions D1, D2 while simultaneously moving the tool 400 downward along the direction D3 to face the sheet 500, removing a thin layer 520 or protruding portion extending outward from the desired face of the sheet 500, yielding a substantially planar face on the mineral wool sheet 500. Further passes may be taken to remove additional material. The direction of cutting of the sheet 500 by the cutting edge 262 is in the direction D3, substantially parallel to the face 510 being faced.

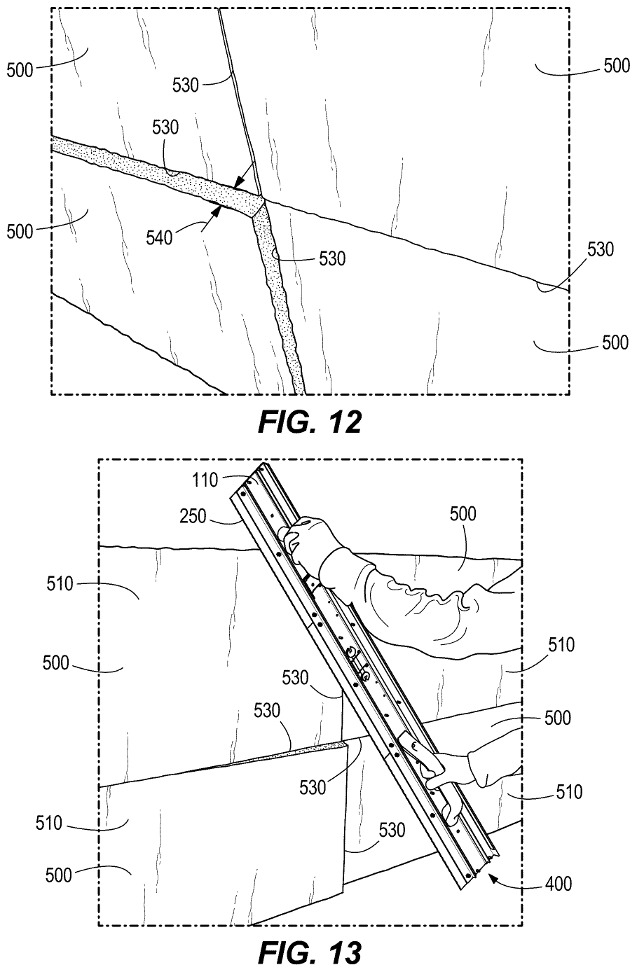

With reference to FIGS. 12-13, the tool 400 (shown in FIG. 13, though could otherwise be the tool 100, 200, or 300) may also clean up the seam 530 between two sheets 500 500 of mineral wool. If a sheet 500 is not aligned with surrounding sheets 500 500, (e.g., caused by excess material on the surface below the sheet 500), the seam 530 between the two adjacent sheets 500 500 may be non-planar. As shown in FIG. 12, the high spot generated by the excess material behind the sheet 500 generates a region having a thickness 540 adjacent the seam 530 that extends outward beyond the plane of the remainder of the sheets 500 500. As shown in FIG. 13, the mineral wool facing tool 400 is used in much the same manner as described above with respect to FIG. 9, with a back-and-forth motion along the length of the tool 400 as the blade 250 is moved into the region of the sheet 500 to be faced. The movement continues until the high spot is removed. As the length of the tool 400 is great enough to remain on at least two adjacent sheets 500 500, the resultant cut, smooth surface, is in-plane with the surrounding sheets 500 500.

If a user wants to provide a cutting motion based on rotation of the mineral wool facing tool 400, rather than translating the tool along the directions D1, D2, the user may rotate the tool 400 about the rotational axis of the first handle 338, with the second hand of the user on the second handle 142 guiding the tool about an arc centered on the first handle 338. Such motion may result in cutting of the mineral wool material 500 in some instances or may otherwise provide an indication to the user of any high points on the surface 510 that are within the swept range of the tool 400.

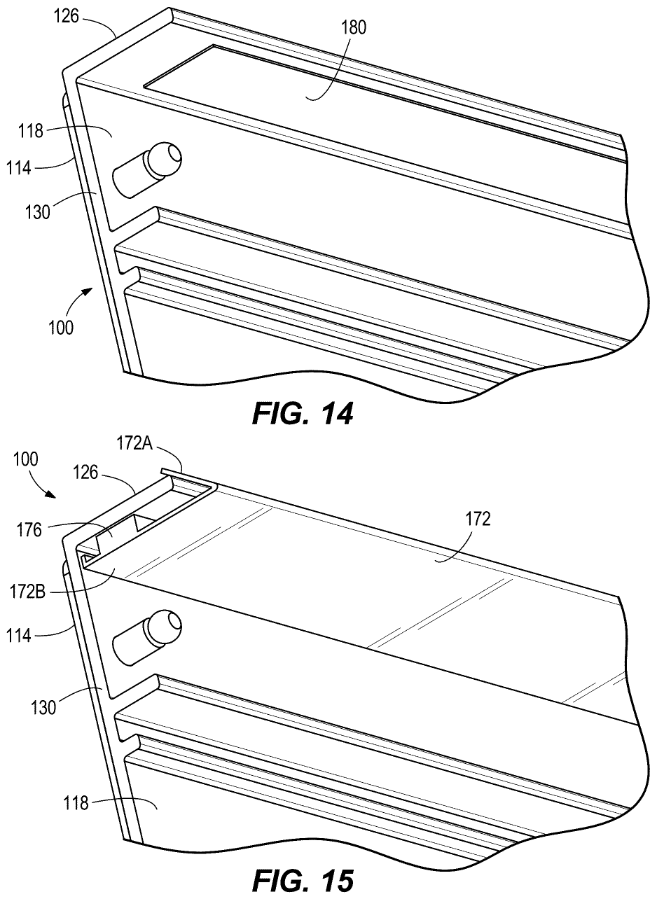

FIGS. 14-15 illustrate a portion of the mineral wool facing tool 100. In particular, an upper corner (at the intersection of the upper edge 126 and the first longitudinal end 130) is illustrated to show one of the protrusions that provides increased rigidity to the tool 100. As shown, the upper protrusion (located at the upper edge 126) extends transverse (e.g., perpendicular) to the main portion of the base 110 of the tool 100, towards the user when in use (as extending away from the user would result in interference with the material to be cut). A ferromagnetic material 180 (e.g., a thin metal strip, a magnetic strip) is affixed to a side (as shown, the lower side) of the protrusion. As shown in FIG. 15, a blade guard 172 may be coupled (e.g., magnetically) to the tool 100 at the ferromagnetic material to store the blade guard 172 while the tool is in use. As shown, the blade guard 172 is generally V-shaped, having a first leg 172A and a second leg 172B that extend over opposite sides of the blade 150 to cover a cutting edge of the blade 150 in a use position (i.e., when the blade guard 172 is in use to guard the blade 150). In the stowed position (when the blade 150 is usable), the blade guard 172 extends over the protrusion, with the first leg 172A extending over the protrusion to the upper edge 126 of the base 110, and the second leg 172B extending to the other side of the protrusion. As shown, the second leg 172B includes a ferromagnetic material 176 (e.g., a magnet, a magnetic metal strip) that magnetically couples the blade guard 172 to the base 110 at the ferromagnetic material 180. The ferromagnetic material 176 of the blade guard 172 may also secure the blade guard 172 to the blade 150. In some embodiments, the base 110 and/or the blade guard 172 may be formed of a ferromagnetic material and would not require a separate ferromagnetic strip 176, 180 affixed thereto.

Although the invention has been described in detail with reference to certain embodiments above, variations and modifications exist within the scope and spirit of one or more independent aspects of the invention as described.

Various features and advantages of the invention are set forth in the following claims.

What is claimed is:

1. A mineral wool facing tool configured to remove material from a rough face of a mineral wool sheet, the mineral wool facing tool comprising:
a base defining:
a first substantially planar surface configured to move along the rough face of the sheet of mineral wool, the substantially planar surface having a height and a length, the length being at least three times greater than the height such that an elongated edge is defined by the first substantially planar surface; and
a second surface opposite the first substantially planar surface and separated from the first substantially planar surface by a thickness of the base, the height and the length of the first substantially planar surface being greater than the thickness;
a first handle coupled to the second surface;
a second handle spaced apart from the first handle and coupled to the second surface; and
a blade having a cutting edge that extends from and along the length of the elongated edge of the base,
wherein in response to sliding movement of the first substantially planar surface of the base along the rough face of the mineral wool sheet, the cutting edge is configured to remove material from the rough face to yield a substantially planar face on the mineral wool sheet.

2. The mineral wool facing tool of claim 1, wherein the blade includes a toothed edge or a scalloped edge.

3. The mineral wool facing tool of claim 1, wherein each of the first handle and the second handle is D-shaped.

4. The mineral wool facing tool of claim 1, wherein the first handle is configured as a knob that is rotatable relative to the base.

5. The mineral wool facing tool of claim 1, wherein the blade extends in a plane, wherein the blade is coplanar with the first substantially planar surface, and wherein the cutting edge is configured to face the rough face within the plane.

6. The mineral wool facing tool of claim 1, wherein the blade is removable from the base and is coupled to the base via a plurality of fasteners.

7. The mineral wool facing tool of claim 1, wherein the base overlaps a portion of the blade along a full length of the blade.

8. The mineral wool facing tool of claim 1, wherein the blade includes a first blade positioned end-to-end adjacent to a second blade.

9. The mineral wool facing tool of claim 1, further comprising a tool holder coupled to the first substantially planar surface and a tool configured to remove the blade from the base coupled to the tool holder.

10. The mineral wool facing tool of claim 1, further comprising a blade guard configured to cover a cutting edge of the blade in a use position and magnetically couple to the base in a stowed position.

11. A method of operating a mineral wool facing tool, the mineral wool facing tool including a base defining a first substantially planar surface configured to move along a rough face of a sheet of mineral wool and a second surface opposite the first substantially planar surface and separated from the first substantially planar surface by a thickness of the base, a first handle coupled to the second surface, a second handle spaced apart from the first handle and coupled to the second surface, and a blade having a cutting edge that extends from and along a length of an elongated edge of the base, the method comprising:
pressing the first substantially planar surface against the rough face of the mineral wool sheet; and
moving the mineral wool facing tool back and forth along a longitudinal direction of the mineral wool facing tool along the rough face while simultaneously moving the mineral wool facing tool downward along the rough face, causing the blade to remove material from the rough face to yield a substantially planar face on the mineral wool sheet.

12. The method of claim 11, wherein moving the mineral wool facing tool back and forth along the longitudinal direction and along the rough face includes moving the mineral wool facing tool over a seam between the mineral wool sheet and an adjacent mineral wool sheet to make the faces of the two adjacent mineral wool sheets coplanar.

13. A mineral wool facing tool configured to remove material from a rough face of a mineral wool sheet, the mineral wool facing tool comprising:
a base defining:
a first substantially planar surface configured to move along the rough face of the sheet of mineral wool, the first substantially planar surface having a height and a length such that an elongated edge is defined by the first substantially planar surface; and
a second surface opposite the first substantially planar surface and separated from the first substantially planar surface by a thickness of the base, the height and the length of the first substantially planar surface being greater than the thickness;
a first handle extending from the second surface;
a second handle spaced apart from the first handle; and
a blade having a cutting edge that extends from and along the length of the elongated edge of the base,
wherein the blade extends in a plane, wherein the blade is coplanar with the first substantially planar surface, and wherein the cutting edge is configured to face the rough face within the plane.

14. The mineral wool facing tool of claim 13, wherein the blade includes a toothed edge or a scalloped edge.

15. The mineral wool facing tool of claim 13, wherein each of the first handle and the second handle is D-shaped.

16. The mineral wool facing tool of claim 13, wherein the first handle is configured as a knob that is rotatable relative to the base.

17. The mineral wool facing tool of claim 13, wherein the blade is removable from the base and is coupled to the base via a plurality of fasteners.

18. The mineral wool facing tool of claim 13, wherein the base overlaps a portion of the blade along a full length of the blade.

19. The mineral wool facing tool of claim 13, wherein the blade includes a first blade positioned end-to-end adjacent to a second blade.

20. The mineral wool facing tool of claim 13, further comprising a tool holder coupled to the first substantially planar surface and a tool configured to remove the blade from the base coupled to the tool holder.
